(19) United States
(12) Patent Application Publication
(10) Pub. No.: US 2005/0003258 A1
(43) Pub. Date: Jan. 6, 2005

(54) Fuel cell system and method to operate a fuel cell system

(76) Inventors: Jochen Sang, Kirchheim/Teck (DE); Andreas Knoop, Esslingen (DE); Falko Berg, Kirchheim (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/805,166

(22) Filed: Mar. 19, 2004

Related U.S. Application Data
(60) Provisional application No. 60/529,418, filed on Dec. 12, 2003.

(30) Foreign Application Priority Data
Mar. 21, 2003 (DE) 103 12 647.3

(51) Int. Cl. H01M 8/04

(52) U.S. Cl. 429/34; 429/13

(57) ABSTRACT

A fuel cell system comprising a fuel cell which contains an anode and a cathode, further comprising a cathode compressor to supply process air to the fuel cell, and an anode compressor to supply fuel gas to the fuel cell, whereby the cathode compressor and the anode compressor can be driven by a common motor drive, and whereby an automatic clutch is provided to couple and decouple the driving of the cathode compressor and the anode compressor.

### CROSS-REFERENCE TO RELATED APPLICATIONS

This application claims the benefit of U.S. Provisional Patent Application No. 60/529,418 filed Dec. 12, 2003, and also claims priority to German Application No. 103 12 647.3 filed Mar. 21, 2003, both of which applications are incorporated herein by reference in their entireties.

### BACKGROUND OF THE INVENTION

1. Field of the Invention

The invention relates to a fuel cell system comprising a fuel cell, which contains one cathode and one anode, further comprising one cathode compressor to supply process air to the fuel cell, and one expansion device in an exhaust gas line issuing from the fuel cell, whereby the cathode compressor is drivable by an electric motor drive and whereby the expansion device is or can be coupled for driving purposes to the cathode compressor via an automatic clutch.

2. Description of the Related Art

Fuel cell systems are known in the prior art. For example, DE 199 51 584 A1 is directed to a fuel cell system in which a compressor is arranged on the cathode side—hereafter referred to as a cathode compressor—to supply process air to the cathode of the fuel cell. This fuel cell system further comprises a generation system for fuel gas, a so-called reformer, that is arranged on the anode side and uses an easily storable hydrocarbon, e.g., methanol, to generate a fuel gas, in particular hydrogen. The fuel gas that is produced by the reformer is then supplied to the anode of the fuel cell. In addition to a hydrocarbon, the fuel-gas generation process requires air, which has to be supplied to the reformer in pressurized form. For this purpose, the fuel cell system is equipped with a compressor on the anode side—hereafter referred to as the anode compressor. Both the cathode compressor and the anode compressor have to be motor-driven during operation of the fuel cell system. Consequently, it is necessary during a (cold-) starting phase of the fuel cell system to supply the reformer with a adequately large quantity of air before the reformer can produce fuel gas. But during this time it is not necessary to supply process air to the fuel cell since the reaction that takes place in the fuel cell has not yet been initiated. During the normal operation of the fuel cell system, after the (cold-) staring phase has ended, the anode compressor and the cathode compressor operate in parallel and provide fuel gas and process air to the fuel cell reaction. In order to make allowances for these different operating profiles of the anode compressor and the cathode compressor, DE 199 51 584 A1 suggests two electric motors, which interact in different ways, depending on the operating phase. However, the implementation of the fuel cell system according to this prior art requires a relatively high hardware complexity.

DE 43 18 818 C2 discloses a fuel cell system in which an expansion device is positioned in an exhaust gas line that originates from the fuel cell. This expansion device expands the exhaust gas of the fuel cell, whereby the pressure energy that is released in that process is converted to mechanical energy and is transferred by means of a shaft connection to the cathode compressor for the purpose of delivering process air. In operating states in which the expansion of the exhaust gases taking place in the expansion device can not generate sufficient mechanical energy to power the cathode compressor—together with the cathode compressor's motor drive—, the expansion device will be dragged by the motor drive of the cathode compressor. This reduces the efficiency of the fuel cell system. A similar solution is disclosed in DE 197 55 116 C1.

DE 199 44 296 A1 discloses a fuel cell system in which the motor drive of the cathode compressor is also coupled via a shaft connection to an expansion device that is associated with the exhaust gas line. But in this case, an electromagnetic clutch prevents the motor drive of the cathode compressor from dragging the expansion device, whereby the electromagnetic clutch is arranged between the expansion device and the motor drive of the cathode compressor and is controlled in dependence on the exhaust gas pressure. This solution is complex with respect to the measurement technology required and additionally requires a control for the electromagnetic clutch. As an alternative, this prior art discloses a freewheel between the motor drive of the cathode compressor and the expansion device. However, because the drive shaft extends out of the motor drive on both sides, this solution is comparatively bulky and requires a large amount of space. Moreover, the long motor shaft increases the mass moment of inertia of the system and reduces the efficiency of the system.

Accordingly, there continues to be a need in this field for improved fuel cell systems.

### BRIEF SUMMARY OF THE INVENTION

In brief, the present invention is directed to a fuel cell system with lower hardware and design complexity in which the cathode compressor and the expansion device can be coupled on demand in order to increase efficiency.

In one embodiment, a fuel cell system is provide that comprises a fuel cell that contains an anode and a cathode, further comprising a cathode compressor to supply process air to the fuel cell, and an expansion device in an exhaust gas line originating in the fuel cell, whereby the cathode compressor can be driven by an electric motor drive, and whereby the driving of the expansion device is or can be coupled with the cathode compressor by means of an automatic clutch. In this fuel cell system according to the invention it is intended that the electric motor drive possesses a driving output, in particular an output shaft, which is used to drive the cathode compressor, and that the expansion device is or can be directly coupled to the cathode compressor via the automatic clutch.

This allows a very compact design of the fuel cell system. In contrast to the prior art according to the above-mentioned DE 199 44 296 A1, it is possible to use a motor with only one output shaft, so that one has more options with respect to the installation and the position of the connectors of the electric motor. Furthermore, this makes is possible to reduce the mass that has to be driven by the motor, in particular the mass of the motor shaft and the associated shaft connections, so that the overall design possesses a lower inertia and a higher efficiency than the state of the art. Moreover, it becomes possible to avoid coaxial arrangements, which require significant amounts of space.

The automatic clutch that couples the cathode compressor with the expansion device may be executed as a direction-dependent clutch, in particular as a freewheel. It may be designed so that it is in a disengaged state for as long as the rotational speed of the expansion device is lower than the rotational speed of the cathode compressor, and that it is in a torque-transmitting engaged state as soon as the rotational speed of the expansion device reaches the rotational speed of the cathode compressor. In this manner, a dragging of the expansion device by the cathode compressor and its motor drive and the resulting decrease in system efficiency can be avoided. In other words, the cathode compressor can “overtake” the expansion device with regard to the respective rotational speeds without torque being transmitted from the cathode compressor to the expansion device. On the other hand, the pressure energy that is released by the expansion of the exhaust gases is used—after its conversion to mechanical energy—to drive the cathode compressor and to ease the load on its motor drive, if this energy is high enough so that the expansion device “overtakes” the cathode compressor with respect to the respective rotational speeds.

Furthermore, this variant of the invention may be associated with a transmission gearbox. This makes it possible to realize various step-up or step-down gear ratios between the individual drive components, such as the motor drive and the expansion device, and the individual components being driven, such as the cathode compressor.

The automatic clutch between the expansion device and the cathode compressor may be executed as a positive clutch, such as a pawl coupling, or as a frictionally engaging clutch, such as a sleeve coupling or friction coupling. Alternatively, the automatic clutch may be realized via the use of torque-dependent clutches or speed-dependent clutches. Other possible design variants for the coupling of various drive shafts are belt drives, chain drives, and even gear-tooth systems, which can be combined with the automatic clutch. This in particular makes it possible to avoid space-consuming coaxial arrangements of drive shafts to be coupled.

The invention further relates to a fuel cell system, in particular a system of the above-described type, comprising one fuel cell, which contains one anode and one cathode, further comprising one cathode compressor to supply process air to the fuel cell, and one anode compressor to supply air to a fuel gas generation system associated with the fuel cell, whereby the cathode compressor and the anode compressor can be driven by a common motor drive, and whereby an automatic clutch is provided for the drive-related coupling and decoupling of the cathode compressor and the anode compressor.

Thus, according to the invention it is not necessary to drive the cathode compressor and the anode compressor separately or to provide a relatively complex drive arrangement, as it has been described above with reference to the prior art of DE 199 51 584 A1. On the contrary, the present invention provides a solution that allows the use of a single motor to drive the anode compressor or the cathode compressor on demand. For example, at first—e.g., in a (cold-) starting phase of the fuel cell system—only the anode compressor is driven while the cathode compressor is decoupled from the mechanical drive by the automatic clutch. Subsequently, e.g., during the transition from the (cold-) starting phase to the standard operating phase of the fuel cell system, the nature of the driving is changed in coordination with the automatic clutch, so that the automatic clutch engages and the cathode compressor will be driven as well.

A simple, space-saving, and at the same time effective realization of the invention can for example be obtained if the anode compressor is coupled to the motor drive and if the motive power can be transferred to the cathode compressor by a shaft connection that includes the automatic clutch. This for example makes it possible to connect the anode compressor and the cathode compressor via a transmission unit that contains the automatic clutch and to combine the compressors into a very compact unit. In this case, the motor drive may be arranged close to the anode compressor in a space-saving manner, avoiding any high-space-requirement coaxial arrangements.

In a further embodiment of the invention, the automatic clutch is executed as a direction-dependent clutch, in particular as a freewheel. Direction-dependent clutches of this type are known in the art and various types are commercially available, for example positive clutches, such as pawl couplings, or frictionally engaging clutches, such as sleeve couplings or friction couplings. As an alternative to a mechanical coupling of the cathode compressor and the anode compressor one can also envision the use of other automatic clutches, such as for example torque-dependent clutches or speed-dependent clutches. In principle one could also envision the use of an electromagnetic clutch, but this would result in significantly higher complexity of the hardware and control equipment. It is also possible to use belt drives or chain drives with free-wheeling functionality to transfer torque between the various shaft connections.

In order to be able to enable a demand-driven mechanical coupling and decoupling of the anode compressor and the cathode compressor by means of a direction-dependent clutch, the invention may further provide that in a first operating state, in which the automatic clutch is in a disengaged state, the motor drive operates in a first direction of rotation, while in a second operating state, in which the automatic clutch is in a torque-transmitting engaged state, the motor drive operates in an opposite, second direction of rotation. In the first operating state, for example the (cold-) starting phase of the fuel cell system, only the anode compressor is rotationally driven by the motor drive while no mechanical drive power is transferred to the cathode compressor, since the automatic clutch is in its disengaged state.

Upon a change of the direction of rotation of the motor drive during the transition from the first operating phase to the second operating phase, for example when the fuel cell system commences normal operation, the automatic clutch will be switched from its disengaged state to its engaged state, so that torque can be transferred to the cathode compressor as well.

It should be noted that the use of a rotational-direction-dependent clutch makes advantageous to use a motor drive that can operate and provide torque in two opposite directions of rotation. In addition, the anode compressor should also be able to operate independent of the direction of rotation. Consequently, a reciprocating compressor may be used at least on the anode side.

The invention may be employable in various types of fuel cell systems. For example, the anode compressor may be used directly for the delivery of already prepared fuel gas, e.g., hydrogen, from a fuel gas reservoir to the fuel cell. But the invention is also particularly suited to be employed in a fuel cell system that contains a reformer to produce fuel gas from a hydrocarbon, e.g., methanol. In view of this fact, in accordance with the invention a reformer for the production of fuel gas may be provided on the anode side and the anode compressor may be associated with the reformer. The anode compressor may for example be used to supply process air to the reformer during a (cold-) starting phase of the fuel cell system to pre-heat the reformer and to heat it to operating temperature. As soon as the reformer has commenced producing fuel gas, the reaction between the fuel gas and the process air in the fuel cell may be initiated, whereupon the cathode compressor is switched on, for example by changing the direction of rotation of the motor drive.

In the preceding sections, the basic principle, as well as some further developments of the invention with regard to a releasable coupling of the anode compressor and the cathode compressor, have been disclosed. For an increase of the efficiency of the fuel cell system, this basic principle can be further developed in an embodiment of the invention so that additionally an expansion device is provided in an exhaust gas line that originates in the fuel cell, whereby the expansion device is or may be coupled on the power-take-off side to the cathode compressor and the anode compressor.

In this further development according to the invention, the expansion device is used to convert the pressure energy stored in the exhaust gases of the fuel cell system into mechanical energy. Subsequently, this mechanical energy can be used—if it is sufficiently high—to drive the cathode compressor or/and the anode compressor.

In this respect, and in yet a further embodiment, an additional automatic clutch may be provided to couple or decouple the drive of the expansion device and the cathode compressor or the anode compressor. This additional automatic clutch makes it possible to ensure that the expansion device will not be dragged by the motor drive of the anode compressor and the cathode compressor, when the pressure energy of the exhaust gases—after being converted to mechanical energy by the expansion device—is not sufficient to contribute to the rotational driving. In this case, the additional automatic clutch ensures that no torque or power is transmitted from the motor drive of the anode compressor and the cathode compressor to the expansion device. It only allows a transmission of torque or power in the direction from the expansion device to the anode compressor and the cathode compressor.

The additional automatic clutch between the expansion device and the anode compressor or cathode compressor may be executed as a direction-dependent clutch as well, in particular as a freewheel. As explained above with regard to the clutch between the anode compressor and the cathode compressor, the additional automatic clutch may be a positive clutch, such as for example a pawl coupling, or a frictionally engaged clutch, such as for example a sleeve coupling or a friction coupling. As an alternative implementation of the additional automatic clutch one can also envision the use of torque-dependent clutches or speed-dependent clutches.

In a further development of the invention, and in regard to the mode of operation of the additional automatic clutch between the expansion device and the anode compressor or the cathode compressor, the additional automatic clutch may be in a disengaged state for as long as the rotational speed of the expansion device is lower than the rotational speed of the cathode compressor and the anode compressor, and that the additional automatic clutch is in a torque-transmitting engaged state as soon as the rotational speed of the expansion device reaches the rotational speed of the cathode compressor or the anode compressor. As a result, the anode compressor and the cathode compressor can “overtake” the expansion device with respect to their respective rotational speeds without torque being transmitted from the anode compressor and the cathode compressor to the expansion device. On the other hand, the pressure energy that is released in the expansion of the exhaust gases is used—after its conversion to mechanical energy—to drive the anode compressor and the cathode compressor and to relieve their motor drive, if it is high enough for the expansion device to “overtake” the anode compressor and the cathode compressor with respect to their respective rotational speeds.

It should be noted that in addition to the automatic clutches that have been explained in detail, other transmission modules, such as step-up gear units or step-down gear units, can be arranged between the individual components of the above-described fuel cell system, such as the anode compressor, cathode compressor, and the expansion device, which are or can be driven in a coupled manner. This does not change the basic mode of operation of the automatic coupling and decoupling of the individual components; but the speed ratios could be different. In specific cases, one could also utilize belt drives, chain drives, and gear transmissions.

The invention further relates to a method to operate a fuel cell system, in particular a fuel cell system of the above-described type, whereby the fuel cell system comprises one fuel cell, which contains one anode and one cathode, further comprises one cathode compressor to supply process air to the fuel cell, and one anode compressor to supply process air to a reformer that is associated with the fuel cell. The method according to the invention intends that the cathode compressor and the anode compressor are driven by a common motor drive, that an automatic clutch is provided to couple and decouple the driving of the cathode compressor and the anode compressor, and that in a first operating state the motor drive only drives the anode compressor, whereby the cathode compressor is decoupled from the motor drive by the automatic clutch, and in a second operating state the motor drive drives both the cathode compressor and the anode compressor.

The method further includes the embodiment wherein the automatic clutch is executed as a direction-dependent clutch, in particular as a freewheel, whereby in the first operating state the motor drive operates in a first direction of rotation, in which the automatic clutch is in a disengaged state, and whereby in the second operating state the motor drive operates in the opposite, second direction of rotation, in which the automatic clutch is in a torque-transmitting engaged state.

Regarding the above-described variant of the invention of the fuel cell system comprising a fuel cell, which contains an anode and a cathode, further comprising a cathode compressor to supply process air to the fuel cell, and an expansion device in an exhaust gas line originating in the fuel cell, the invention further provides a method in which the cathode compressor is driven by an electric motor drive and in which the driving of the expansion device and the cathode compressor is coupled via an automatic clutch. This method further intends that the electric motor drive possesses one drive output, in particular one output shaft, that it uses to drive the cathode compressor, and that in a first operating state the cathode compressor is driven by the motor drive and the expansion device is decoupled from the cathode compressor by the automatic clutch, while in a second operating state the cathode compressor is coupled with the motor drive and the expansion device and is driven by both the motor drive and the expansion device.

In a still further embodiment, the automatic clutch coupling the cathode compressor with the expansion device is executed as a direction-dependent clutch, in particular a freewheel, whereby in the first operating state the motor drive together with the cathode compressor rotates faster than the expansion device, so that the automatic clutch that couples the cathode compressor to the expansion device is in its disengaged state, and whereby in the second operating state the motor drive, the cathode compressor, and the expansion device rotate together, so that the automatic clutch that couples the cathode compressor and the expansion device is in a torque-transmitting engaged state.

### BRIEF DESCRIPTION OF THE SEVERAL VIEWS OF THE DRAWING(S)

In the following, the invention will be described with the help of embodiment examples, which are illustrated in the enclosed drawings.

FIG. 1 shows a schematic representation of a first embodiment example of a fuel cell system according to the invention.

FIG. 2a shows a schematic representation of a second embodiment example of a fuel cell system according to the invention.

FIG. 2b shows a schematic representation of a fuel cell system according to the invention with slight modifications with respect to the embodiment example of FIG. 2a.

FIG. 3 shows a schematic representation of a third embodiment example of a fuel cell system according to the invention.

### DETAILED DESCRIPTION OF THE INVENTION

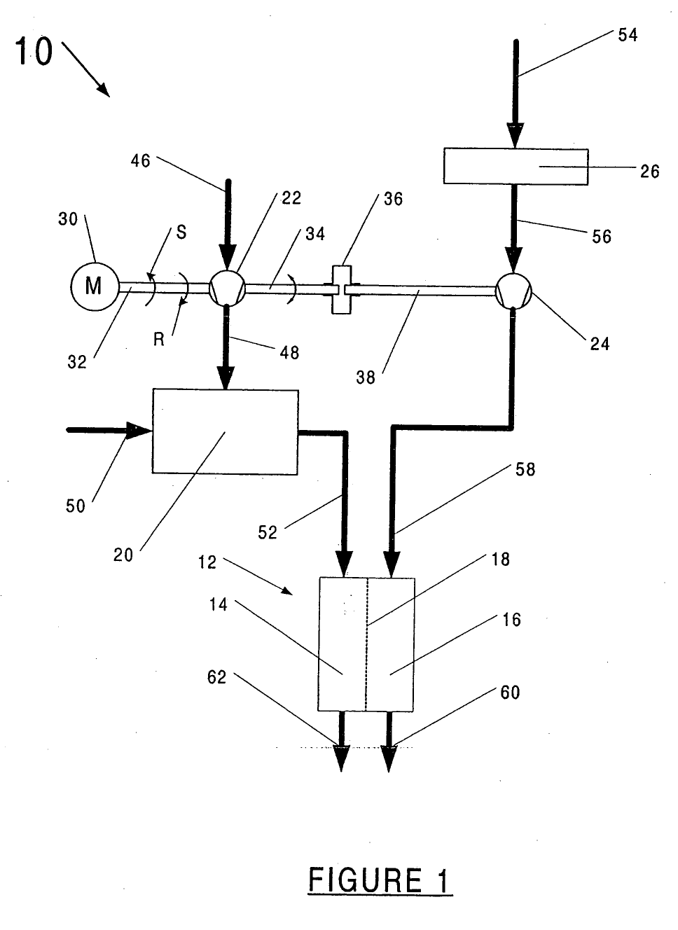

In FIG. 1, the entirety of a first embodiment example of a fuel cell system according to the invention is labeled 10. It comprises fuel cell 12, which is operated in a manner known in the art to generate power from a fuel gas, e.g., hydrogen, and an oxidant, e.g., oxygen, which is obtained from supplied ambient air. The fuel cell is a PEM fuel cell (PEM: Proton Exchange Membrane), i.e., a fuel cell with a proton exchange membrane. The fuel cell 12 possesses an anode side 14 and a cathode side 16, which are separated by the proton exchange membrane 18.

The fuel cell system 10 further comprises reformer 20, which is arranged on the anode side and generates a fuel gas from a starting gas, e.g., a hydrocarbon. A compressor 22 is connected upstream of the reformer 20, whereby the compressor—due to being associated with the anode side 14 of the fuel cell 12—hereafter will be referred to as the anode compressor 22.

The fuel cell system 10 is also equipped with a compressor 24 on the cathode side, which hereafter will be referred to as the cathode compressor 24. The purpose of the cathode compressor 24 is to supply process air to the cathode side 16 of the fuel cell 12. An air filter 26 is connected upstream of the cathode compressor 24 to remove impurities from the process air.

The anode compressor 22 is mechanically coupled to an electric motor 30 via a shaft connection 32 and is rotationally driven by the electric motor 30. The electric motor 30 is executed so that it delivers torque to the shaft connection 32 in both directions of rotation, R and L. The anode compressor 22 is executed as a reciprocating compressor and functions irrespective of the running direction of the electric motor 30.

The anode compressor 22 in turn is mechanically coupled to the cathode compressor 24 via a shaft connection 34, a freewheel 36, and a further shaft connection 38. When the electric motor 30 rotates in the rotational direction labeled L, the freewheel 36 allows the two shaft connections 34 and 36 to essentially rotate freely with respect to each other without any torque transfer, and when the electric motor 30 rotates in the direction labeled R, the freewheel 36 serves to lock the two shaft connections with respect to each other so that they engage in a torque-transferring manner.

At this point it should be pointed out that the freewheel 36 may also be executed in different ways to couple the shaft connections, for example via a gear-tooth system that locks only in one rotational direction or via a different transmission arrangement with freewheel functionality.

The normal operation of the fuel cell system 10 with the above-described configuration proceeds as follows: Air is drawn in by the anode compressor 22 through a line 46 from the surroundings and is forced into the reformer 20 through a line 48. For this, the anode compressor 22 is rotationally driven by the electric motor 30 via the shaft connection 32, whereby for rotations of the electric motor in any of the directions of rotation R and L, the anode compressor 22 delivers ambient air into the reformer 20. Furthermore, a hydrocarbon, e.g., methanol, is supplied to the reformer 20 through a line 50. The reformer 20 converts the supplied substances to a fuel gas, e.g., hydrogen, which is then conducted to the anode 14 of the fuel cell 12 via a line 52.

On the cathode side, air from the surroundings is drawn in through an air supply line 54 by the cathode compressor 24, and after being filtered in the air filter 26, is supplied to the cathode 16 of the fuel cell 12 via the lines 56 and 58. During this, the cathode compressor 24 is rotationally driven by the electric motor 30, via the shaft connection 34, the freewheel 36 that is in its engaged state, and the shaft connection 38.

During this, the electric motor 30 rotates in the direction of rotation labelled R, in which the freewheel 36 transmits torque. If the electric motor were to rotate into the direction of rotation labelled L, the freewheel 36 would not transfer any torque to the shaft connection 38. During this the shaft connection 34 rotates together with the shaft connection 32. This can be achieved by rigidly connecting the two shaft connections 32 and 34.

Inside the fuel cell, protons are exchanged across the membrane 18, which—in a manner known in the art and consequently not explained here—results in the generation of power, which can then be used by a load, which is not shown here.

Before the above-described normal operation can commence, it is desirable during a cold start of the fuel cell system 10 to supply air from the anode compressor 22 to the reformer 20 via the lines 46 and 48 to bring the reformer to operating temperature before it can commence fuel gas production. However, driving the cathode compressor 24 so that it can deliver process air is not yet necessary during this start-up phase, since the reaction in the fuel cell 12 has not yet been initiated. Consequently, the energy that would be required to drive the cathode compressor 24 may be saved. In order to achieve this, during the start-up phase the electric motor 30 rotates in the direction of rotation labeled L. During a rotation of this nature, the freewheel 36 is in its disengaged state, so that no torque is transmitted to the cathode compressor 24. After the end of the start-up phase, the electric motor 30 changes its direction of rotation and rotates in the direction of rotation labelled R. For this direction of rotation the freewheel 36 is in its torque-transmitting engaged state, so that the cathode compressor 24 will be driven as well. The anode compressor 22 is designed to supply air to the reformer 20 via the line 48 irrespective of the direction of rotation of the electric motor 30.

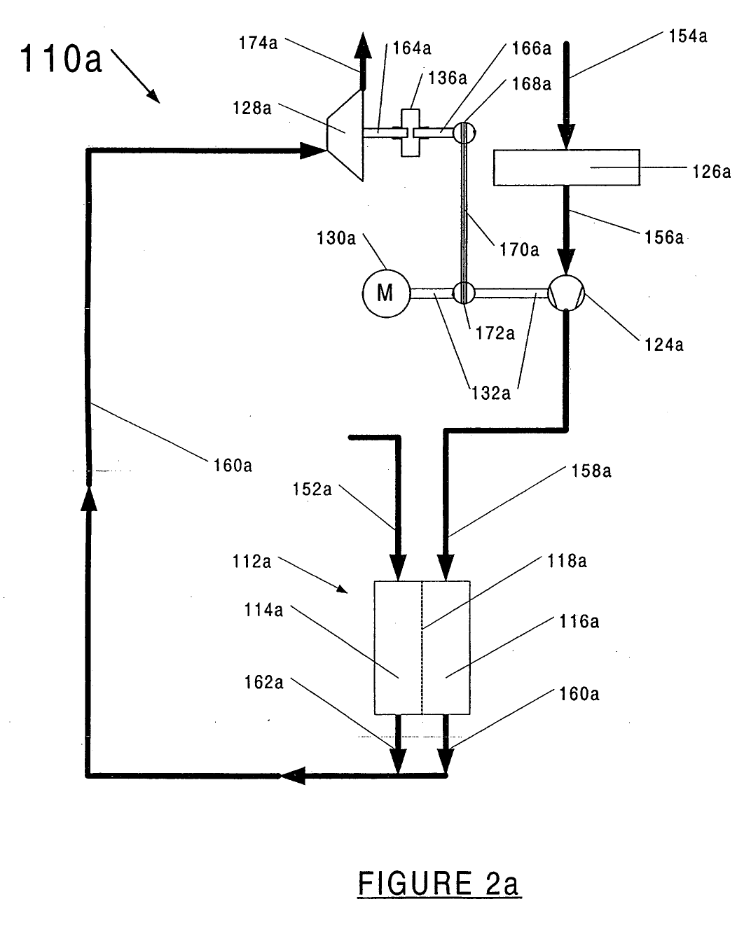

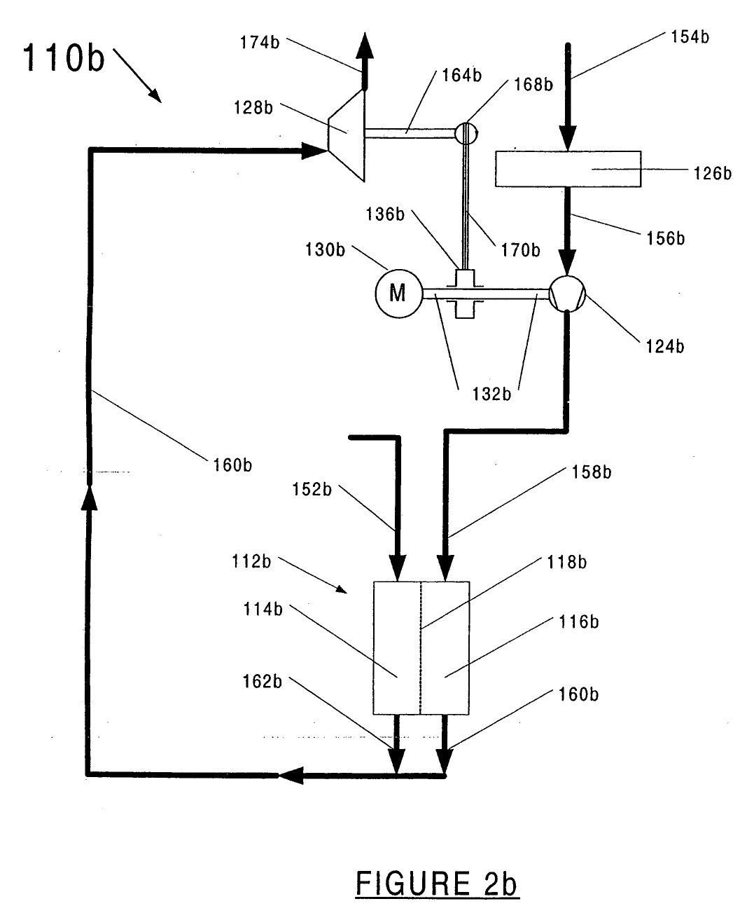

FIGS. 2a and 2b show different variants of a second embodiment example of a fuel cell system according to the invention. The design and mode of operation of the two variants are very similar. At first we will deal with the fuel cell system 110a shown in FIG. 2a. To simplify the description, we will use the same reference labels for identical components or components with identical functions as in the description of the first embodiment example according to FIG. 1, except that they are preceded by the digit “1” and followed by the letter “a”.

As already explained with reference to FIG. 1, the fuel cell system 110a comprises fuel cell 112a that contains anode side 114a and cathode side 116a, which are separated from each other by a proton exchange membrane 118a. The anode side 114a is supplied with a fuel gas, e.g., hydrogen, via a supply line 152a. The cathode side 116a is supplied with pressurized filtered process air via a supply line 154a, an air filter 126a, a further supply line 156a, a cathode compressor 124a, and a supply line 158a. During this, the cathode compressor 124a is driven by means of a motor 130a, whereby the motor's rotation is transferred directly to the cathode compressor 124a via a shaft connection.

The fuel cell system 110a further comprises an expansion device 128a, from which originates an output shaft 164a. The output shaft 164a is coupled to an intermediate shaft 166a via a freewheel 136a. The mode of operation of the freewheel 136a is such that it only transfers torque to the intermediate shaft 166a for one direction of rotation of the output shaft 164a, while in the opposite direction of rotation it allows an essentially free rotation between the output shaft 164a and the intermediate shaft 166a.

On the freewheel-distant end of the intermediate shaft 166a is attached a rotationally fixed pulley 168a, which via a belt 170a is coupled for torque-transfer purposes to a pulley 172a attached rotationally fixed on the shaft connection 132a.

Inside the fuel cell 112a, protons are exchanged across the membrane 118a, which—in a manner known in the art and consequently not explained here—results in the generation of power, which can then be used by a load, which is not shown here. During this, exhaust gas is produced, which contains water vapor and is supplied to the expansion device 128a via an exhaust gas line 160a. Opening into the exhaust gas line 160a is an exhaust gas line 162a, through which excess fuel gas—if present—is discharged from the anode side 114b. In the expansion device 128a, the exhaust gas is expanded, which releases pressure energy that is converted to mechanical rotational energy in the expansion device 128a and is transmitted to the output shaft 164a. After the expansion, the exhaust gas is discharged to the surroundings via an exhaust gas line 174a. Due to the expansion of the exhaust gas in the expansion device 128a, the output shaft 164a rotates in the same direction of rotation as the intermediate shaft 166a, which is rotationally driven by the motor 130a that drives the cathode compressor 24, via the shaft connection 132a and the belt drive consisting of the pulley 172a, the belt 170a, and the pulley 168a.

As long as the output shaft 164a of the expansion device 128a rotates at a slower speed than the intermediate shaft 166a, which is rotationally driven by the electric motor 130a, the freewheel 136a will be in a state in which it allows a differential rotation between the output shaft 164a and the intermediate shaft 166a. But as soon as the rotational speed of the output shaft 164a reaches or exceeds the rotational speed of the intermediate shaft 166a, the freewheel 136a locks and transfers torque from the output shaft 164a to the intermediate shaft 166a. From there, the torque can be transferred via the belt drive, consisting of the pulley 168a, the belt 170a, and the pulley 172a, to the shaft connection 132a. As a result of this, when the output shaft 164a rotates rapidly enough, the rotational energy of the expansion device 128a can be utilized to drive the cathode compressor 124a.

Providing the freewheel 136a between the drive of the cathode compressor 124a and the output shaft 164a of the expansion device 128a makes it possible to prevent the expansion device 128a from being rotationally driven by the drive of the cathode compressor 124a via a fixed shaft connection, i.e., from being “dragged”, which would reduce the efficiency of the fuel cell system. This condition could arise if during the expansion of the exhaust gases in the expansion device 128a only a small amount of mechanical energy were generated and made available for the rotational driving of the cathode compressor 124a.

In addition to an efficient utilization of the mechanical energy gained in the expansion device 128a, the arrangement shown in FIG. 2a offers further advantages. The output shaft 164a of the expansion device 128a and the shaft connection 132a are not arranged coaxially, but are coupled by a belt drive, which offers some design flexibility with respect to the arrangement. As a result of this, the fuel cell system 110a can have a more compact design. In addition, the mechanical energy obtained from the expansion device 128a can be supplied directly to the cathode compressor 124a via the shaft connection 132a that originates in the electric motor 130a, so that there is no need for additional shaft connections to introduce the torque into the cathode compressor 124a or for a longer dimensioning of the shaft connection 132a. The use of a belt drive also makes it possible to realize transmission ratios in the transmission of the rotation from the output shaft 164a to the shaft connection 132a, which allows a more efficient utilization of the rotation of the output shaft for the purpose of driving the cathode compressor. The transmission ratios can, for example, be achieved by different dimensions of the pulleys 168a and 172a.

It should be noted that instead of using a belt drive, it is possible to use a chain drive, a gear drive, or other arrangements to couple the intermediate shaft 166a and the shaft connection 132a.

The variant of the invention of FIG. 2b shows a fuel cell system 110b, which differs from the invention's variant of FIG. 2a only with regard to the transfer of the mechanical energy generated in the expansion device 128b to the cathode compressor 124b. For this reason, we will explain only these differences, using the same reference symbols as in the description of FIG. 2a, but this time with the letter “b” appended.

In the embodiment according to FIG. 2b, the freewheel 136b is arranged in the area of the shaft connection 132b between the electric motor 130b and the cathode compressor 124b. It sits directly on the shaft connection 132b that connects the electric motor 130b with the cathode compressor 124b. The freewheel 136b is coupled via the belt 170b to the pulley 168b, which is arranged rotationally fixed at the end of the output shaft 164b. The shaft connection 132b turns with respect to the freewheel 136b without transferring torque to the freewheel until the freewheel 136b, driven by the expansion device 128b, rotates sufficiently rapidly. Then it transfers the rotary motion of the output shaft 164b to the shaft connection 132b as additional driving force for the cathode compressor 124b.

Apart form this, the two variants of the second embodiment example according to FIGS. 2a and 2b are identical with respect to design, mode of operation, and advantages.

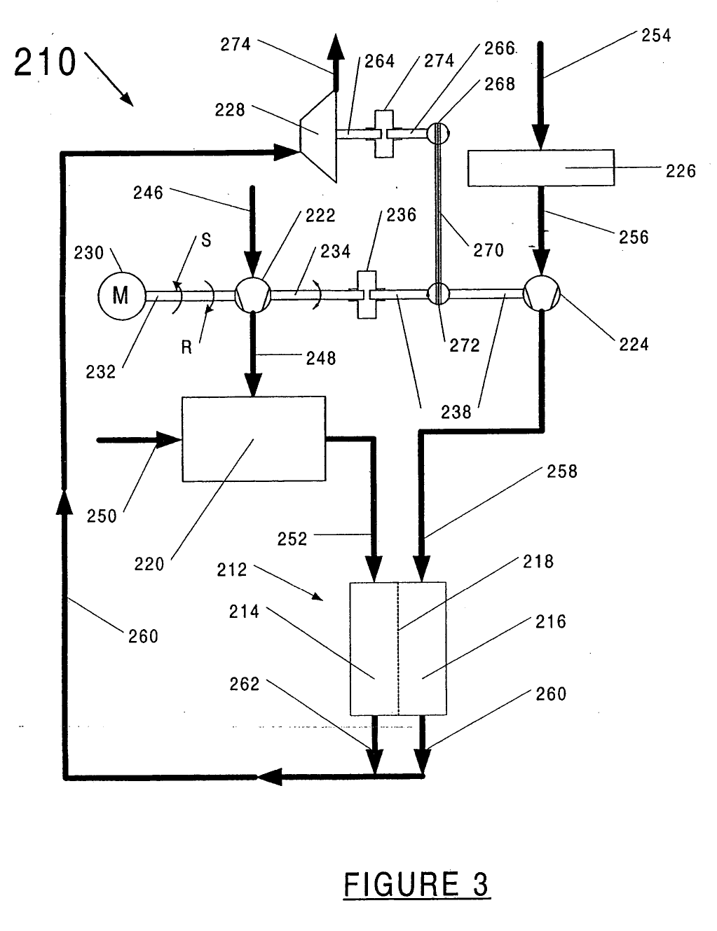

FIG. 3 shows a third embodiment example of a fuel cell system 210 according to the invention. To prevent repetition, the same reference labels are used as in the description of the first and second embodiment examples according to FIGS. 1 and 2, except that they are preceded by the digit “2” and that no letters are appended.

The embodiment of FIG. 3 is a combination of the two embodiments of FIG. 1 and FIG. 2a. FIG. 3 shows a fuel cell 212 with one anode side 214 and one cathode side 216, which are separated from each other by a proton exchange membrane 218. As already described in reference to FIG. 1, the anode side 214 is supplied with fuel gas via a supply line 252. The fuel gas, e.g., hydrogen, is produced in a reformer 220 from a hydrocarbon supplied via a supply line 250 and ambient air, whereby the latter is drawn in via a supply line 246 by means of an anode compressor 222 and is delivered to the reformer via a supply line 248. As already explained in reference to FIG. 1, on the cathode side a cathode compressor 224 draws in process air from the surroundings via a supply line 254, through an air filter 226, and via a supply line 256, and from the cathode compressor 224 the pressurized process air is delivered into the fuel cell 212 via a supply line 258.

The anode compressor 222 and the cathode compressor 224 are driven by a common electric motor 230, which delivers torque in two directions of rotation R and L. The anode compressor 222 delivers process air to the reformer 220, irrespective of the direction of rotation of the electric motor 230. The anode compressor can for example be executed as a reciprocating compressor. The driving of the cathode compressor 224 and the anode compressor 222 is coupled via two shaft connections 234 and 238, which in turn may be coupled by means of a freewheel 236. The freewheel 236 allows a differential rotation between the shaft connections 234 and 238 in one direction of rotation (L), but engages in the case of a differential rotation in the other direction of rotation (R), so that in this direction of rotation it transfers torque from the shaft connection 234 to the shaft connection 238.

The fuel cell system 210 further comprises—as already described in reference to FIG. 2a—an expansion device 228, from which extends an output shaft 264. The output shaft 264 is coupled to an intermediate shaft 266 via a freewheel 274. The mode of operation of the freewheel 274 is as follows: it only transfers torque to the intermediate shaft 266 in one direction of rotation of the output shaft 264, while for the opposite direction of rotation it allows an essentially free rotation between the output shaft 264 and the intermediate shaft 266. Attached in a rotationally fixed manner to the freewheel-distant end of the intermediate shaft 266 is a pulley 268, which is coupled to the shaft connection 238 via a belt 270. This coupling can also be realized by incorporating the freewheel 236; in this case the belt 270 directly drives the freewheel 236.

The operation of the fuel cell system 210 proceeds as follows:

Initially, during a cold start of the system, the electric motor 230 rotates in the direction of rotation L to deliver ambient air to the reformer 220 by means of the anode compressor 222 and thus to heat the reformer to operating temperature. When the electric motor 230 rotates in the direction of rotation L, no torque is transferred by the freewheel 236 to the shaft connection 238 and thus to the cathode compressor 224. Consequently, no torque is transferred from the electric motor 230 to the intermediate shaft 266. This means that in this operating phase only the anode compressor 222 is driven.

Once the reformer 220 has reached operating temperature, the direction of rotation of the electric motor is reversed from L to R. During a rotation in the rotational direction R, the freewheel 236 engages and torque is transferred from the electric motor 230 to the anode compressor 222, and via the engaged freewheel 236 to the cathode compressor 224, so that the cathode compressor will be rotationally driven as well and can deliver process air to the fuel cell 212. During such a rotation of the freewheel 236, the freewheel transfers torque to the intermediate shaft 266 by means of the belt 270 and the pulley 268.

Now, the fuel cell 212 generates power in the manner known in the art. Exhaust gases produced during this are carried to the expander 228 via the exhaust gas line 260. In the expander 228 the exhaust gases are expanded, whereby mechanical rotational energy is produced, which is output via the output shaft 264. No torque is transmitted as long as the rotational speed of the output shaft 264 is lower than the rotational speed of the intermediate shaft 266, which is driven via the freewheel 236 and the belt 270, and the freewheel 274 allows a differential rotation between these shafts. This prevents the expansion device 228 from being rotationally driven by the electric motor 230 and from being dragged unnecessarily, which would decrease the efficiency of the fuel cell system 210. The freewheel 274 only engages when the rotational speed of the output shaft 264 reaches or “overtakes” the rotational speed of the intermediate shaft 266, whereupon torque is transmitted from the output shaft 264 to the intermediate shaft 266. This torque is then transferred via the pulley 268 and the belt 270 to the freewheel 236 and is utilized to drive the cathode compressor 224. This eases the load on the electric motor 230 and increases the overall efficiency of the fuel cell system by utilizing the energy being released in the expansion device 228.

The configuration according to FIG. 3 has the further advantage that the anode compressor 222, the cathode compressor 224, and the expansion device 228 are directly coupled with each other and that the anode compressor 224 in turn is coupled directly with the motor 230. For this reason, the motor 230 only requires one output shaft 232, which reduces the moment of inertia of the rotating components of the fuel cell system, which gives the system higher energy efficiency than would be the case for the prior art in accordance with DE 199 44 296 A1, for example.

It should be pointed out that the above-described embodiment examples according to the FIGS. 1, 2a and 2b, as well as 3 do not constitute a final explanation of the invention. For example, it is also possible to combine the embodiment example according to FIG. 1 with the embodiment example according to FIG. 2b. Furthermore, the shaft couplings that are implemented via belt drives and are shown in the figures and explained above can equally be realized with chain drives, frictional gears, toothed gears, or other types of couplings.

The above-described invention discloses a solution for a fuel cell system that is uncomplicated with respect to its mechanical design and hardware, in which the anode compressor and the cathode compressor are driven on demand and can be driven by only a single motor drive. Furthermore, the invention provides a way to increase the efficiency of the fuel cell system by utilizing the energy stored in the exhaust gases issuing from the fuel cell.

Any and all of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. Fuel cell system, comprising:
a fuel cell having an anode and a cathode;
a cathode compressor for supplying process air to the fuel cell;
an expansion device connected to the fuel cell via an exhaust gas line;
wherein the cathode compressor is capable of being driven by an electric motor drive and the expansion device is or is capable of being coupled for driving purposes with the cathode compressor via an automatic clutch; and
wherein the electric motor drive is equipped with a drive output that drives the cathode compressor and the expansion device is or is capable of being coupled directly with the cathode compressor via the automatic clutch.

2. The fuel cell system of claim 1 wherein the drive output is an output shaft.

3. The fuel cell system of claim 1 wherein the automatic clutch is a direction-dependent clutch.

4. The fuel cell system of claim 3 wherein the direction-dependent clutch is a freewheel.

5. The fuel cell system of claim 1 wherein the automatic clutch is in a disengaged state when the rotational speed of the expansion device is lower than the rotational speed of the cathode compressor, and is in a torque-transmitting engaged state when the rotational speed of the expansion device reaches the rotational speed of the cathode compressor.

6. The fuel cell system of claim 1, wherein a step-up gear unit or step-down gear unit is associated with the automatic clutch.

7. The fuel cell system of claim 1, wherein a chain drive or belt drive is associated with the automatic clutch.

8. The fuel cell system of claim 1 wherein the automatic clutch is equipped with teeth.

9. A fuel cell system, comprising:
a fuel cell having an anode and a cathode;
a cathode compressor to supply process air to the fuel cell;
an anode compressor to supply air to a fuel gas generation system associated with the fuel cell; and
wherein the cathode compressor and the anode compressor are driven by a common motor drive and an automatic clutch is provided for coupling and decoupling the cathode compressor and the anode compressor.

10. The fuel cell system of claim 9, wherein the anode compressor is coupled to the motor drive and its operating energy is capable of being transferred to the cathode compressor via a shaft connection that includes the automatic clutch.

11. The fuel cell system of claim 9, wherein the automatic clutch is a direction-dependent clutch.

12. The fuel cell system of claim 11 wherein the direction-dependent clutch is a freewheel.

13. The fuel cell system of claim 11, wherein in a first operating state the automatic clutch is in a disengaged state and the motor drive rotates in a first direction of rotation, and in a second operating state the automatic clutch is in a torque-transmitting engaged state and the motor drive rotates in a second direction of rotation that is opposite to the first direction.

14. The fuel cell system of claim 9, wherein a reformer for the generation of fuel gas is provided on the anode side of the fuel cell, and wherein the anode compressor is associated with the reformer.

15. The fuel cell of claim 14 wherein the anode compressor is connected upstream of the reformer.

16. The fuel cell system of claim 9, wherein an expansion device is associated with an exhaust gas line originating from the fuel cell, and wherein the driving of the expansion device is or is capable of being coupled with the cathode compressor and the anode compressor.

17. The fuel cell system of claim 16, wherein an additional automatic clutch is provided for the coupling and decoupling of the driving of the expansion device and the cathode compressor or the anode compressor.

18. The fuel cell system of claim 17 wherein the additional automatic clutch is a direction-dependent clutch.

19. The fuel cell system of claim 18 wherein the additional direction-dependent clutch is a freewheel.

20. The fuel cell system of claim 18, wherein the additional automatic clutch is in a disengaged state for as long as the rotational speed of the expansion device is lower than the rotational speed of the cathode compressor and the anode compressor, and is in a torque-transmitting engaged state when the rotational speed of the expansion device reaches the rotational speed of the cathode compressor or the anode compressor.

21. A method for operating a fuel cell system, comprising providing a fuel cell system comprising a fuel cell having an anode and a cathode, a cathode compressor to supply process air to the fuel cell, and an expansion device connected to the fuel cell via an exhaust gas line, and driving the cathode compressor by an electric motor drive coupled by an automatic clutch with the expansion device and the cathode compressor, wherein the electric motor drive is equipped with a drive output which drives the cathode compressor, and wherein in a first operating state the cathode compressor is driven by the motor drive and the expansion device is decoupled from the cathode compressor by the automatic clutch, and in a second operating state the cathode compressor for driving purposes is coupled with the motor drive and the expansion device and is driven by both the motor drive and the expansion device.

22. The method of claim 21 wherein the automatic clutch that couples the cathode compressor with the expansion device is a direction-dependent clutch, whereby in a first operating state the motor drive together with the cathode compressor rotates faster than the expansion device, so that the automatic clutch that couples the cathode compressor with the expansion device is in its disengaged state, and whereby in a second operating state the motor drive, the cathode compressor, and the expansion device rotate together, so that the automatic clutch that couples the cathode compressor with the expansion device is in a torque-transmitting engaged state.

23. A method of operating a fuel cell, comprising providing a fuel cell comprising a fuel cell having an anode and a cathode, a cathode compressor to supply process air to the fuel cell, and an anode compressor to supply fuel gas to the fuel cell, and driving the cathode compressor and the anode compressor by a common motor drive, wherein an automatic clutch is provided for the coupling and decoupling of the driving of the cathode compressor and the anode compressor, and wherein in a first operating state only the anode compressor is driven by the motor drive, whereby the cathode compressor is decoupled from the motor drive by the automatic clutch, and in a second operating state both the cathode compressor and the anode compressor are driven by the motor drive.

24. The method of claim 23 wherein automatic clutch is a direction-dependent clutch, wherein in a first operating state the motor drive rotates in a first direction of rotation, in which the automatic clutch is in a disengaged state, and in a second operating state the motor drive rotates in an opposite, second direction of rotation, in which the automatic clutch is in a torque-transmitting engaged state.
